(19) United States
(12) Patent Application Publication
(10) Pub. No.: US 2005/0104951 A1
(43) Pub. Date: May 19, 2005

(54) Thermal transfer image-receiving sheet

(75) Inventors: Naoyuki Mitsuyasu, Tokyo (JP); Taro Suzuki, Tokyo (JP)

Correspondence Address: BIRCH STEWART KOLASCH & BIRCH, PO BOX 747, FALLS CHURCH, VA, 22040-0747, US

(73) Assignee: Dai Nippon Printing Co., Ltd., Tokyo (JP)

(21) Appl. No.: 10/950,566

(22) Filed: Sep. 28, 2004

(30) Foreign Application Priority Data
Sep. 29, 2003 (JP) 2003-337435

(51) Int. Cl. B41J 2/315

(52) U.S. Cl. 347/171

(57) ABSTRACT

A thermal transfer image-receiving sheet comprising: a receiving layer comprising a polyester resin, which is formed on at least one of faces of a substrate sheet as an outermost surface layer, wherein the receiving layer has a storage elastic modulus of not less than 2,000 [Pa] and a loss elastic modulus of not less than 10,000 [Pa] as dynamic viscoelasticity at 160° C. and the resin component contains an alicyclic carboxylic acid and/or an alicyclic diol.

### BACKGROUND OF THE INVENTION

1. Field of the Invention

This invention relates to a thermal transfer image-receiving sheet that is superposed on a thermal transferring sheet and used.

2. Description of the Related Art

With respect to an image-forming method in which thermal transferring processes are utilized, a method (sublimation-type thermal transfer system) in which a thermal transfer sheet formed by allowing a substrate sheet such as paper and a plastic film to support a sublimable dye serving as a recording material and a thermal transfer image-receiving sheet in which a receiving layer for the dye is formed on paper or a plastic film are superposed on each other so that a full-color image is formed has been known. In this method, since the sublimable dye is used as the color material, the density and tone are freely adjustable on a dot basis so that it is possible to clearly form a full-color image faithful to an original document on an image-receiving sheet. Therefore, this method is applied to color-image forming processes of images in digital cameras, videos and computers. The resulting image is a high-quality image comparable to a silver-salt photograph.

With respect to the image printed and formed through the sublimable thermal transfer system, in addition to high image quality, light resistance as high as that of silver-salt photograph is required. In order to satisfy such high light resistance, a process in which, after yellow, magenta and cyan images have been printed on a thermal transfer image-receiving sheet, a protective layer is laminated on the images has been widely used. In particular, a thermal transfer image-receiving sheet in which a polyester-based resin (in particular, polyester resin) is used as its receiving layer is poor in light resistance so that there have been strong demands for laminating a protective layer of polyester-based resin.

With respect to a binder for the thermal transfer sheet, an acetal-based resin (in particular, acetal resin) has been mainly used, but there is a problem that in the case when a polyester-based resin is used as the receiving layer, upon printing, the acetal-based resin and a polyester-based resin tend to be thermally fused each other, making it difficult to maintain a releasing property between the thermal transfer sheet and the image-receiving sheet.

In order to maintain a sufficient releasing property, for example, techniques in which a large amount of a releasing agent such as silicone is added to the receiving layer have been known (for example, Japanese Patent Application Laid-Open No. 08-108636, and Japanese Patent Application Laid-Open No. 2002-264543). However, these techniques cause problems such as a poor preserving property of the printed-article and a failure in transferring the protective layer although a sufficient releasing property is obtained, making it difficult to maintain the releasing property and the protective-layer transferring property in a well-balanced manner.

### SUMMARY OF THE INVENTION

The present invention is to provide a thermal transfer image-receiving sheet that provides a superior releasing property between a thermal transfer sheet and an image-receiving sheet upon printing an image and a superior protective-layer transferring property.

Another object of the present invention is to provide a thermal transfer receiving sheet having improved light resistance.

The present invention relates to a thermal transfer image-receiving sheet comprising:
a receiving layer comprising a polyester resin, which is formed on at least one of faces of a substrate sheet as an outermost surface layer,
wherein the receiving layer has a storage elastic modulus of not less than 2,000 [Pa] and a loss elastic modulus of not less than 10,000[Pa] as dynamic viscoelasticity at 160° C. and the resin component contains an alicyclic carboxylic acid and/or an alicyclic diol.

### DETAILED DESCRIPTION OF THE INVENTION

The inventors of the present invention have found that by properly specifying dynamic viscoelasticity of the receiving layer of the thermal transfer image-receiving sheet and the amount of addition of a release agent, it becomes possible to achieve the above-mentioned objectives.

The present invention relates to a thermal transfer image-receiving sheet comprising:
a receiving layer comprising a polyester resin, which is formed on at least one of faces of a substrate sheet as an outermost surface layer,
wherein the receiving layer has a storage elastic modulus of not less than 2,000 [Pa] and a loss elastic modulus of not less than 10,000 [Pa] as dynamic viscoelasticity at 160° C.

The receiving layer of the thermal transfer sheet of the present invention comprises a polyester resin. The polyester is obtained by a condensation-polymerizing process between a dicarboxilic acid component (including derivatives thereof) and a diol component (including derivatives thereof). The polyester resin contains an aromatic ring and/or an alicyclic ring.

The dicarboxylic acid component is selected from isophthalic acid, trimellitic acid, terephthalic acid, 1,4-cyclohexane dicarboxylic acid and a mixture of two or more kinds thereof. Preferably, the component is selected from isophthalic acid, trimellitic acid, terephthalic acid and a mixture of two or more kinds thereof. It is desirable from the viewpoint of improving the light resistance to contain the dicarboxylic acid component having an alicyclic component. More preferably, 1,4-cyclohexane dicarboxylic acid and isophthalic acid are used.

The dicarboxylic acid component is prepared and used at a mixing ratio of isophthalic acid (50 to 100 mol %), trimellitic acid (0 to 1 mol %), terephthalic acid (0 to 50 mol %) and 1,4-cyclohexane dicarboxylic acid (0 to 15 mol %) so as to form the total of 100 mol %.

The diol component is selected from ethylene glycol, polyethylene glycol, tricyclodecane dimethanol, 1,4-butane diol, bisphenol, and a mixture of two or more kinds thereof. Preferably, the diol component is selected from ethylene glycol, polyethylene glycol and tricyclodecane dimethanol. It is desirable from the viewpoint of improving the light resistance to contain the diol component having an alicyclic component. In addition to tricyclodecane dimethanol, an alicyclic diol component such as cyclohexane diol, cyclohexane dimethanol and cyclohexane diethanol may be used. A preferable alicyclic diol component is tricyclodecane dimethanol.

The diol component is prepared and used at a mixing ratio of ethylene glycol (0 to 50 mol %), polyethylene glycol (0 to 10 mol %), tricyclodecane dimethanol (0 to 90 mol %, preferably 30 to 90 mol %, more preferably 40 to 90 mol %), 1,4-butane diol (0 to 50 mol %) and bisphenol A (0 to 50 mol %) so as to form the total of 100 mol %.

The polyester resin to be used in the present invention is prepared by using at least the dicarboxylic acid component and diol component that are polycondensed to have a molecular weight (weight average molecular weight (Mw)) of about not less than 11,000, preferably about not less than 15,000, more preferably about not less than 17,000. When the molecular weight is too low, the elastic modulus of a receiving layer to be formed is lowered and the heat resistance thereof becomes insufficient, with the result that it becomes difficult to maintain a proper releasing property between the thermal transfer sheet and the image-receiving sheet. From the viewpoint of increasing the elastic modulus, the greater the molecular weight, the better; therefore, although not particularly limited as long as problems, such as insolubility to a coating solvent upon forming the receiving layer and adverse effects in adhesive property to the substrate sheet after coating and drying processes of the receiving layer, are not raised, the molecular weight is preferably set to about not more than 25,000, and is set to about 30,000 at most. With respect to the synthesizing method for the ester resin, any of conventional methods may be used.

The receiving layer of the thermal transfer sheet of the present invention is formed through processes in which the above-mentioned polyester resin is dissolved or dispersed in an appropriate solvent, such as methylethyl ketone, toluene, xylene, ethyl acetate, acetone or a mixed solvent thereof, together with additives such as a release agent, a curing agent and other desired additives, to form a coating solution and this solution is applied onto a substrate sheet by using a commonly-used method, such as a wire bar, a roll coater or a gravure coater, and dried thereon. The amount of coat is normally set to from 1 to 6 g/m², preferably on the order of 2 to 4 g/m².

With respect to the substrate sheet, various transparent to opaque plastic films and sheets and various kinds of paper, such as synthetic paper, quality paper, art paper, coated paper, cast-coated paper, wallpapers, backing papers, synthetic-resin or emulsion impregnation paper, synthetic plastic impregnation paper, synthetic-resin internally-added paper and paperboards, are preferably used. The thickness of these substrate sheets may be optionally set, and is generally set in a range of approximately 130 to 200 μm.

With respect to the release agent that is used for ensuring the releasing property between the thermal transfer sheet and the image-receiving sheet upon printing an image, those known release agents in the corresponding technical field, such as silicone oil, phosphate-based compounds and fluorine-based compounds, may be used. Silicone oil is preferably used. With respect to the silicone oil, modified silicones, such as epoxy-modified, alkyl-modified, amino-modified, fluorine-modified, phenyl-modified, epoxy-polyether-modified silicones, vinyl-modified silicone oil or OH-modified silicone having active hydrogen atoms are preferably used. The release agent is used at a rate in a range from 2 to 4% by weight, preferably from 2 to 3% by weight, with respect to 100 parts by weight of polyester resin. When the content is too low, it becomes impossible to positively ensure the releasing property. When the content is too high, the protective layer is not transferred onto the image-receiving sheet.

The curing agent is used so as to react with active hydrogen atoms in the polyester so that the polyester resin is crosslinked and cured; thus, the receiving layer is allowed to have heat resistance. With respect to the curing agent, for example, isocyanate and chelate compounds may be used. In the case when an OH-modified silicone having active hydrogen atoms is used as the release agent, the curing agent also reacts with the modified silicone so as to fix the release agent in the receiving layer so that it becomes possible to prevent bleeding and the like of the release agent to the surface; therefore, the application thereof in combination is one of preferable embodiments of the present invention. With respect to the curing agent, isocyanate compounds of the non-yellow-color-change type are preferably used. Specific examples thereof include: xylenediisocyanate (XDI), hydrogenated XDI, isophoronediisocyanate (IPDI) and hexamethylenediisocyanate (HDI), and adducts/burettes, oligomers, prepolymers of these. In addition to these, those isocyanate compounds, which start the reaction within a period of time in which the solvent for the receiving-layer coating solution has been dried, may be used as long as they are of the non-yellow-color-change type. The content of the curing agent is set in a range from 1 to 4% by weight, preferably approximately from 2 to 3% by weight, with respect to 100 parts by weight of the polyester resin. When the content is too small, it is not possible to increase the elastic modulus of the receiving layer. When the content is too high, the elastic modulus becomes unnecessarily large.

A catalyst may be added to the isocyanate compound as a reaction assistant, and any of known catalysts may be used. A typical example of the catalyst is a tin-based catalyst or di-n-butyl tin dilaureate (DBTDL). In addition to this, dibutyl-tin fatty-acid salt-based catalysts, monobutyl-tin fatty-acid salt-based catalysts and monooctyl-tin fatty-acid salt-based catalysts and dimers of these are effectively used. As the amount of tin per weight becomes larger, the reaction rate becomes higher Therefore, the kinds, combination and amount of addition are properly selected in accordance with the isocyanate compound to be used. In the case when a block-type isocyanate compound is used, a block dissociation catalyst may be effectively used in combination.

In the present invention, heating, drying and curing processes are carried out so that the receiving layer has a storage elastic modulus of not less than 2,000 [Pa] and a loss elastic modulus of not less than 10,000 [Pa] as the dynamic viscoelasticity at 160° C. In the present invention, the storage elastic modulus and the loss elastic modulus represent the dynamic viscoelasticity at 160° C. unless otherwise indicated.

In general, the dynamic viscoelasticity is expressed as follows:
E*=E′+iE″ [Pa]
E′=E*cos
E″=E* sin

In the above-mentioned equations, E* indicates a complex elastic modulus and E′ indicates a storage elastic modulus. Elastic characteristics of the sample are reflected by these factors, and these factors means a scale for energy that is required for a stress applied per one cycle to be stored and recovered completely. E″ indicates a loss elastic modulus, and elastic characteristics of the sample are reflected by this factor, and this factor means a scale for energy to be consumed as heat per one cycle.

In the present invention, the dynamic viscoelasticity of the receiving layer is indicated by values obtained through processes in which: after a thermal transfer image-receiving sheet has been prepared, a sample is taken from the image-receiving sheet, and the sample is measured by using a dynamic viscoelasticity measuring device (ARES; made by Rheometrics) in a temperature range from 100 to 160° C. to obtain viscoelastic properties, that is, a storage elastic modulus and a loss elastic modulus at 160° C. The present invention uses values obtained by using the ARES. Any measuring device and method, however, may be used as long as the device and method carry out measurements based upon the same principle and conditions, and the measured values thereof may be applicable in the same manner as those values obtained by the ARES. The measured values of the present invention are not intended to be limited to those values obtained by the ARES.

With respect to the thermal transfer image-receiving sheet of the present invention, layers, such as an antistatic layer, a cushion layer and an intermediate layer to which a white pigment and a fluorescent whitener are added, may be formed between the substrate sheet and the receiving layer, if necessary, or layers such as an antistatic layer, a writing layer and an ink-jet receiving layer may be formed on the face of the substrate sheet on the side opposite to the receiving layer formation side.

The thermal transfer image-receiving sheet of the present invention to be used upon carrying out thermal transferring processes may be applied to a conventional thermal transfer sheet in which a dye layer containing a sublimable dye is formed on paper or a polyester film, and in particular, when used in combination with a thermal transfer sheet in which the dye ink layer is formed of a polyacetal-based resin (in particular, acetal resin) serving as the binder resin and a protective layer is formed of a polyester-based resin, the effects of the present invention are exerted most effectively.

[Effects of the Invention]

The thermal transfer image-receiving sheet of the present invention is superior in its releasing property, protective-layer transferring property and heat resistance as well as light resistance.

The following description will discuss the present invention by means of examples. Polyesters, used for forming the receiving layer of the thermal transfer image-receiving sheet of the present examples, are summarized as shown below.

TABLE 1

| | | EST-A | EST-B | EST-C | V-200 | V-290 | EST-D | EST-E | EST-F |
|---|---|---|---|---|---|---|---|---|---|
| acid | isophthalic acid | 99 | 80 | 85 | 75 | 50 | 50 | 85 | 100 |
| component | terephthalic acid | | 20 | | 25 | 50 | 50 | | |
| | 1,4-cyclohexane | | | 15 | | | | 15 | |
| | dicarboxylic acid | | | | | | | | |
| | trimellitic acid | | | | | | | | |
| diol | ethylene glycol | 12 | 14 | 14 | 58 | 50 | 10 | | 39 |
| | polyethylene glycol | | | | | | | 10 | |
| | tricyclodecane | 40 | 40 | | | | 90 | 30 | 61 |
| | dimethanol | | | | | | | | |
| | 1,4-butane diol | 48 | 48 | 86 | | | | 60 | |
| | bisphenol A | | | | | 50 | | | |

| | | | | | | | | |
|---|---|---|---|---|---|---|---|---|
| density | 1.248 | 1.246 | 1.225 | 1.260 | 1.257 | 1.225 | 1.226 | 1.247 |
| molecular weight (Mw) | 19000 | 23000 | 17000 | 17000 | 23000 | 5000 | 5000 | 5000 |
| Tg (° C.) | 59 | 60 | 80 | 68 | 73 | 87 | 57 | 58 |

### EXAMPLE 1

Synthetic paper, YUPO FPG#150 (made by Oji-Yuka Synthetic Paper Co., Ltd.) having a thickness of 150 μm, was used as a substrate sheet. A receiving layer coating solution having the following composition is applied to one of the faces by using a wire bar at a rate so as to have 2.5 g/m² when dried, and the coated sheet was dried (at 130° C., 40 seconds) to obtain an image-receiving sheet of the present invention.

| | |
|---|---|
| Polyester resin EST-A (Mw: 19,000) (solids: 30%) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| S-CAT-52A (made by Sankyo | 0.1 parts by weight |
| Organic Chemicals Co., Ltd.) | |
| Methylethyl ketone/Toluene = 1/1 (weight ratio) | 50 parts by weight |

The dynamic viscoelasticity of the resulting receiving layer was measured by using a dynamic viscoelasticity measuring device ARES made by Rheometrics. Values obtained at 160° C. are shown below:
Storage elastic modulus: 13,000 [Pa]
Loss elastic modulus: 16,000 [Pa]

### EXAMPLE 2

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-B (Mw: 19,000) (solids: 30%) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| S-CAT-52A (made by Sankyo | 0.1 parts by weight |
| Organic Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 3,200 [Pa]

Loss elastic modulus: 10,000 [Pa]

### EXAMPLE 3

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-C (Mw: 17,000) (solids: 30%) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| S-CAT-52A (made by Sankyo | 0.1 parts by weight |
| Organic Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 2,000 [Pa]

Loss elastic modulus: 10,000 [Pa]

### COMPARATIVE EXAMPLE 1

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin V-200 (Mw: 17,000) | 100 parts by weight |
| (made by Toyobo Co., Ltd.) | |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| S-CAT-52A (made by Sankyo | 0.1 parts by weight |
| Organic Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 2,000 [Pa]

Loss elastic modulus: 10,000 [Pa]

### COMPARATIVE EXAMPLE 2

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin V-290 (Mw: 23,000) (made | 100 parts by weight |
| by Toyobo Co., Ltd.) | |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| S-CAT-52A (made by Sankyo Organic | 0.1 parts by weight |
| Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 6,300 [Pa]

Loss elastic modulus: 13,000 [Pa]

### COMPARATIVE EXAMPLE 3

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-D (Mw5,000) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| Stann BL (made by Sankyo Organic | 0.1 parts by weight |
| Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 320 [Pa]

Loss elastic modulus: 3,200 [Pa]

### COMPARATIVE EXAMPLE 4

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-E (Mw5,000) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| Stann BL (made by Sankyo Organic | 0.1 parts by weight |
| Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 320 [Pa]

Loss elastic modulus: 3,200 [Pa]

### COMPARATIVE EXAMPLE 5

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-F (Mw5,000) | 100 parts by weight |
| X-62-1421B (made by Shin-Etsu | 0.3 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 1.5 parts by weight |
| Stann BL (made by Sankyo Organic | 0.1 parts by weight |
| Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 100 [Pa]

Loss elastic modulus: 1,500 [Pa]

### COMPARATIVE EXAMPLE 6

The same processes as those of example 1 were carried out except that a receiving-layer coating solution having the following composition was used to prepare a thermal transfer image-receiving sheet, and the dynamic viscoelasticity of the resulting receiving layer was measured.

| | |
|---|---|
| Polyester resin EST-F (Mw5,000) | 100 parts by weight |
| X-62-1421B (made by Shin-Etsu | 0.6 parts by weight |
| Chemical Co., Ltd.) | |
| KF-615A (made by Shin-Etsu Chemical Co., Ltd.) | 0.3 parts by weight |
| A-14 (made by Takeda Pharmaceutical Co., Ltd.) | 6.0 parts by weight |
| Stann BL (made by Sankyo Organic | 0.1 parts by weight |
| Chemicals Co., Ltd.) | |
| Methylethyl ketone/Toluene = 1/1 (weight ratio) | 50 parts by weight |

Dynamic viscoelasticity of the receiving layer (160° C.)

Storage elastic modulus: 100 [Pa]

Loss elastic modulus: 1,500 [Pa]

(Evaluation)

By using a P-330 (made by Olympus Corporation) as an evaluation printer, as well as using a standard ribbon for P-330 as an evaluation ribbon, transferring property and releasing property of the protective layer and heat resistance and light resistance of the receiving layer were evaluated. With respect to the binder resin of the dye ink layer of the evaluation ribbon, an acetal resin was used. The results are summarized and shown in Table 2 below.

Protective-Layer Transferring Property:

After having printed a solid-white image by using a P-330, the image was visually evaluated based upon the following criteria.

o: The protective layer was transferred onto the entire printed image area;

x: The protective layer was insufficiently transferred onto the printed image area.

Releasing Property:

After having printed a solid-black image by using a P-330, the printed article was visually evaluated based upon the following criteria.

o: The printing processes were carried out without causing any problems;

x: Abnormal transferring due to binder fusion.

Heat Resistance in the Receiving Layer:

After having printed a solid-black image by using a P-330, the printed article was evaluated and ranked in the following manner, based upon the same criteria as that in the visual evaluation used in the releasing property to which the dynamic viscoelasticity of the receiving layer was further incorporated.

o: The printing processes were carried out without causing any problems;

x: Abnormal transferring due to binder fusion.

Light Resistance:

After having printed a tone pattern by using a P-330, the printed article was subjected to irradiation with 400 KJ by using a light-resistant property accelerator (Ci-4000 made by Atlas Electric Devices Co.), and the density change and color difference before and after the irradiation were evaluated by using a color meter (Macbeth densitometer RD-918, made by Sakata Inx Corporation) and a chromameter (CR321; made by Minolta Co., Ltd.) based upon the following criteria:

o: Not more than ΔE10

Δ: Not less than ΔE10

TABLE 2

| | strage elastic | loss elastic | protective layer | | heat resistance | |
|---|---|---|---|---|---|---|
| | modulus | modulus | transferring | releasing | of receiving | light |
| | [Pa] | [Pa] | property | property | layer | resistance |
| Example1 | 13000 | 16000 | ◯ | ◯ | ◯ | ◯ |
| Example2 | 3200 | 10000 | ◯ | ◯ | ◯ | ◯ |
| Example3 | 2000 | 10000 | ◯ | ◯ | ◯ | ◯ |
| Comparative | 2000 | 10000 | ◯ | ◯ | ◯ | Δ |
| Example 1 | | | | | | |
| Comparative | 6300 | 13000 | ◯ | ◯ | ◯ | Δ |
| Example 2 | | | | | | |
| Comparative | 320 | 3200 | ◯ | X | X | ◯ |
| Example 3 | | | | | | |
| Comparative | 320 | 3200 | ◯ | X | X | ◯ |
| Example 4 | | | | | | |
| Comparative | 100 | 1500 | ◯ | X | X | ◯ |
| Example 5 | | | | | | |
| Comparative | 100 | 1500 | X | ◯ | ◯ | Δ |
| Example 6 | | | | | | |

1. A thermal transfer image-receiving sheet comprising:
a receiving layer comprising a polyester resin, which is formed on at least one of faces of a substrate sheet as an outermost surface layer,
wherein the receiving layer has a storage elastic modulus of not less than 2,000 [Pa] and a loss elastic modulus of not less than 10,000 [Pa] as dynamic viscoelasticity at 160° C. and the resin component contains an alicyclic carboxylic acid and/or an alicyclic diol.

2. The thermal transfer image-receiving sheet according to claim 1, wherein the receiving layer comprises a release agent in a range from 2 to 4% by weight and a curing agent in a range from 1 to 4% by weight with respect to 100 parts by weight of the polyester resin.

3. The thermal transfer image-receiving sheet according to claim 1, wherein the polyester contains a dicarboxilic acid component including a derivative thereof and a diol component including a derivative thereof.

4. The thermal transfer image-receiving sheet according to claim 3, wherein the dicarboxylic acid component is selected from the group consisting of isophthalic acid, trimellitic acid, terephthalic acid, 1,4-cyclohexane dicarboxylic acid and a mixture of two or more kinds thereof.

5. The thermal transfer image-receiving sheet according to claim 3, wherein the diol component is selected from the group consisting of ethylene glycol, polyethylene glycol, tricyclodecane dimethanol, 1,4-butane diol, bisphenol, and a mixture of two or more kinds thereof.

6. The thermal transfer image-receiving sheet according to claim 4, wherein the dicarboxylic acid component is selected to have a mixing ratio of isophthalic acid (50 to 100 mol %), trimellitic acid (0 to 1 mol %), terephthalic acid (0 to 50 mol %) and 1,4-cyclohexane dicarboxylic acid (0 to 15 mol %) so as to form the total of 100 mol %.

7. The thermal transfer image-receiving sheet according to claim 5, wherein the diol component is selected to have a mixing ratio of ethylene glycol (0 to 50 mol %), polyethylene glycol (0 to 10 mol %), tricyclodecane dimethanol (0 to 90 mol %), 1,4-butane diol (0 to 50 mol %) and bisphenol A (0 to 50 mol %) so as to form the total of 100 mol %.

8. The thermal transfer image-receiving sheet according to claim 1, wherein the polyester has a weight average molecular weight (Mw) of about not less than 11,000.

9. The thermal transfer image-receiving sheet according to claim 2, wherein the releasing agent is silicone oil.

10. The thermal transfer image-receiving sheet according to claim 9, wherein the silicone oil is selected from epoxy-modified silicone, alkyl-modified silicone, amino-modified silicone, fluorine-modified silicone, phenyl-modified silicone, epoxy-polyether-silicone, vinyl-modified silicone or OH-modified silicone having active hydrogen atoms.
